(19) United States
(12) Patent Application Publication
(10) Pub. No.: US 2003/0182585 A1
(43) Pub. Date: Sep. 25, 2003

(54) Hand-written input authentication apparatus, hand-written input authentication method and storage medium storing hand-written input authentication program

(75) Inventors: Tadashi Murase, Nagoya (JP); Takashi Maeda, Nagoya (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/279,124

(22) Filed: Oct. 24, 2002

(30) Foreign Application Priority Data
Mar. 19, 2002 (JP) 2002-075333

(51) Int. Cl. H04L 9/32

(52) U.S. Cl. 713/202

(57) ABSTRACT

When a user's signature is registered, an authentication server presents a password to the user. When the user hand-writes the password using an input device, the password and hand-written signature information are registered in a dictionary. At the time of authentication, the authentication server requests the user to hand-write the password. When the user hand-writes the password in response to the request, a signature information control unit compares the signature information newly hand-written by the user and the signature information registered in the dictionary, and outputs the result.

### BACKGROUND OF THE INVENTION

1. Field of the Invention

The present invention relates to a system, a method and a program for authenticating a user based on hand-written input.

2. Description of the Related Art

Recently, technology for authenticating users has spread in order to improve security in an information-based society. For example, authentication systems are used to restrict access to computers. In this case, when a user uses the computer, the authentication system checks whether the user is authorized. If the user is not authorized, the use of the computer is prohibited.

For means of realizing such user authentication, a method using a password predetermined for each user is popular. However, a password may be stolen or a user may forget their password. Therefore, currently, biometric authentication is becoming popular.

Since in biometric authentication, the physical features of a user are utilized as information used to authenticate the user, the physical feature cannot be stolen nor forgotten like a password. As one biometric authentication method, a technology utilizing hand-written signatures is put into practical use.

As shown in FIG. 1, in an authentication system using a hand-written signature, the user's signature information (hand-written writing trace data) is usually registered in an authentication server in advance. In this case, user's signature information is obtained by having a user write their name. Signature information is registered in relation to a user. When authenticating a user, the user is requested to write their name again. In this case, the authentication server authenticates the user by comparing the newly obtained signature information with the signature information registered in advance.

However, since a conventional hand-written signature authentication system usually authenticates a user using their hand-written name, as described above, there may be the following problems.

(1) If a “user name” is used for authentication information, it may be easily forged by another person. Specifically, since the user frequently writes his/her name in his/her daily life, other people frequently see the signature. Therefore, it is possible for a person to obtain and forge another person's signature. This problem is not only limited to a “name”, but can also occur if public information about the person is used as authentication information.

(2) It is generally known that the more complex signatures have better authentication accuracy. Therefore, if a person's name is composed of a few simple characters, authentication accuracy is reduced, and, there is greater risk of being forgery.

(3) When a user signs his/her name using an input device, his/her written character string and the like is usually displayed on a display device. Therefore, the written character string used as registration information can be seen and forged.

### SUMMARY OF THE INVENTION

It is an object of the present invention to prevent forgery in a hand-written input authentication system. It is another object of the present invention to improve the authentication accuracy of a hand-written input authentication system.

According to the hand-written input authentication method of the present invention, a user is authenticated based on his or her hand-written input. In a registration procedure, a password is presented to a user and signature information hand-written by the user in response to the presentation is registered. In an authentication procedure, a user is requested to hand-write the password presented to the user in the registration procedure, and the user is authenticated based on the result of comparing the signature information hand-written by the user in response to the request and the registered signature information.

According to this method, a character string used to compare user's signature can be selected regardless of theuser's attributes (in particular, his or her name, etc.). Thus, since a complex character string, from which high authentication accuracy can be expected, can be used, security is improved. It is difficult for another person to forge this character string. Therefore, this point also contributes to improving security.

According to the hand-written input authentication method in another aspect of the present invention, in a registration procedure, signature information hand-written by a user is broken down into written strokes and registered. In an authentication procedure, signature information newly hand-written by a user is broken down into written strokes, and the user is authenticated based on the result of comparing the signature information obtained in the authentication procedure with the signature information registered in the registration procedure stroke by stroke.

According to this method, since a user's signature is compared for each written stroke, the signature can be compared even if a plurality of characters constituting the password overlap. In this case, if a plurality of characters are overlap, the possibility that a user's signature may be successfully forged is reduced, and the input area for the hand-written signature can also be reduced in size.

### BRIEF DESCRIPTIONS OF THE DRAWINGS

FIG. 1 shows the sequence of general hand-written signature authentication.

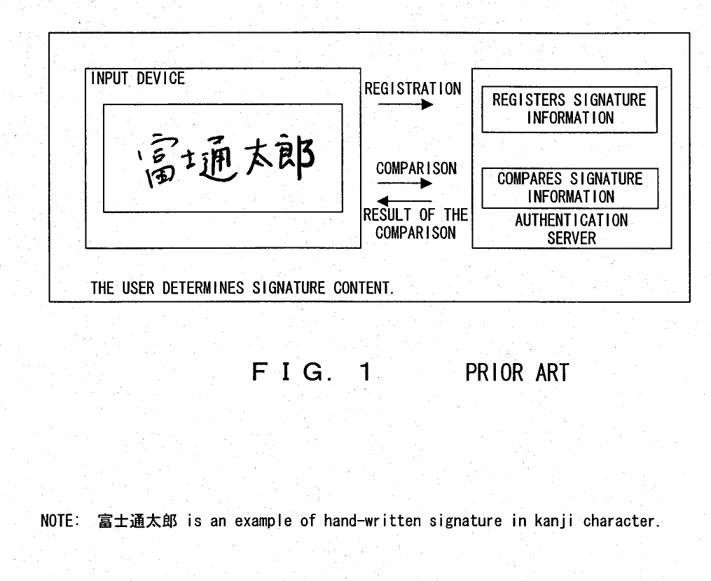

FIG. 2 shows the hardware configuration of the hand-written input authentication system in the embodiment of the present invention.

FIG. 3 shows the data structure of signature information.

FIG. 4 is a flowchart showing a basic operation performed by an authentication server in a registration procedure.

FIG. 5 is a flowchart showing a basic operation performed by an authentication server in an authentication procedure.

FIG. 6 shows the process flow of an authentication method in the first embodiment.

FIG. 7 shows information registered in the first embodiment.

FIG. 8 is a flowchart showing the process of an authentication server in the registration procedure of the first embodiment.

FIG. 9 is a flowchart showing the process of an authentication server in the authentication procedure of the first embodiment.

FIGS. 10A and 10B show the concept of the second embodiment.

FIG. 11 shows the process flow of the authentication method of the second embodiment.

FIG. 12 shows the structure of a dictionary in the second embodiment.

FIG. 13 shows an example of signature information.

FIG. 14 is a flowchart showing the process of an authentication server in the registration procedure of the second embodiment.

FIG. 15 is a flowchart showing the process of an authentication server in the authentication procedure of the second embodiment.

FIG. 16 is a flowchart showing the process for analyzing signature information for each stroke.

FIG. 17 shows a method for making a user select their writing hand.

FIG. 18 shows the process flow of an authentication method in the third embodiment.

FIG. 19 is a flowchart showing the process of an authentication server in the registration procedure of the third embodiment.

FIG. 20 is a flowchart showing the process of an authentication server in the authentication procedure of the third embodiment.

FIGS. 21A and 21B show examples of alphabetic signatures.

FIG. 22 shows the configuration of a computer executing a program on which the functions of the present invention are recorded.

FIG. 23 shows a method for providing the software program of the present invention.

### DESCRIPTION OF THE PREFERRED EMBODIMENTS

The embodiments of the present invention are described below with reference to the drawings.

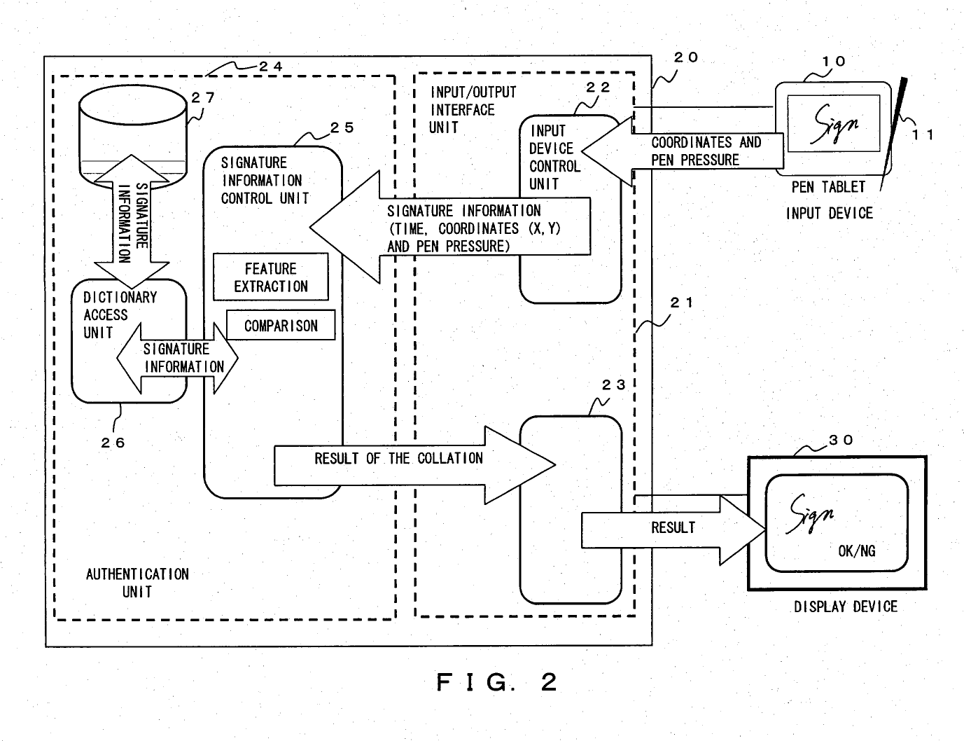

FIG. 2 shows the hardware configuration of the hand-written input authentication system in the embodiment of the present invention. The hand-written input authentication system of the embodiment comprises an input device 10, an authentication server 20 and a display device 30.

The hardware configuration of the hand-written input authentication system of the embodiment is basically the same as that of a general hand-written signature authentication system. However, in the system of the embodiment, information used for authentication is not necessarily limited to a “user name”, and another character string, a figure or a symbol is also often used.

The input device 10 is realized by, for example, a pen tablet system. Here, the input device 10 receives the user's input using a pen 11. Specifically, the input device 10 is provided with an input area. A user can draw a desired pattern (character, figure, symbol, etc.) in the input area using the pen 11. In this case, the input device 10 detects the coordinates (x,y) of the position pressed by the pen 11 and the pen pressure at prescribed intervals. This “pen pressure” information can be binary data, indicating whether the pen 11 touches the input area of the input device 10. Then, the input device 10 relays of the detected coordinate data and pen pressure data to the authentication server 20.

The authentication server 20 comprises an input/output interface unit 21 and an authentication unit 24, and is implemented by a computer. The input/output interface unit 21 controls the transmission/reception of data between the input device 10 and authentication unit 24 and also controls the transmission/reception of data between the authentication unit 24 and display unit 30. The authentication unit 24 compares a hand-written signature input by a user and authenticates the user. The input/output interface unit 21 and authentication unit 24 can be implemented by one computer or be implemented by two or more independent computers. If the input/output interface unit 21 and authentication unit 24 are implemented by two or more independent computers, the computers are connected through a network. In this case, this network can be a private network or a public network. In addition, part of the network or the entire network can also be wireless network.

An input device control unit 22 creates signature information by attaching time data to the coordinate data and pen pressure data detected by the input device 10, and sends the signature information to the authentication unit 24. This signature information is not limited to information relating to a hand-written signature, and it includes information relating to a hand-written character, figure or symbol. In other words, to “sign” generally means to write one's name, however, in this specification, it is not limited to “writing one's name” and it shall also mean “to write a character, figure and/or symbol used for user authentication”.

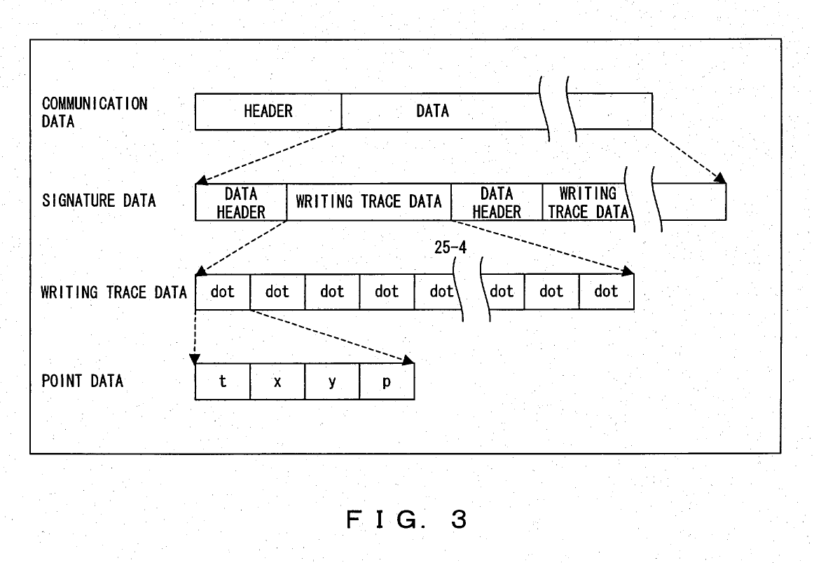

FIG. 3 shows the data structure of signature information. This signature information is composed of a lot of “point data (dots)”. Here, each piece of “point data” is composed of coordinate data (x,y) and pen pressure data (p) that are detected by the input device 10 at prescribed time intervals and time data (t) indicating the time when corresponding coordinate data and pen pressure data were detected.

“Writing trace data” comprises a plurality of “point data”. Here, one set of “writing trace data” comprises a plurality of “point data” obtained by one hand-written input. That is to say, if a user repeatedly signs his or her name three times, three sets of “writing trace data” are created. A data header is attached to each piece of “writing trace data”. Furthermore, when the “writing trace data” with a data header are sent from the input device control unit 22 to the authentication unit 24, the data are stored in the data area of “communication data”.

A display control unit 23 creates display data based on the coordinate data and the like detected by the input device 10, and sends the display data to the display device 30. In this way, the signature pattern hand-written by a user using the input device 10 is displayed on the display device 30. Information used to create display data (coordinate data and the like) can be directly received from the input device control unit 22 or be received through the authentication unit 24. The display control unit 23 receives the result of user authentication (result of the comparison) from the authentication unit 24 and displays the result on the display device 30.

On receipt of signature information from the input device control unit 22 in a procedure for registering a user's signature, a signature information control unit 25 registers the signature information in a dictionary 27 through a dictionary access unit 26. In this case, the signature information is registered using a user ID as a retrieval key. The user ID uniquely identifies the user.

On receipt of signature information from the input device control unit 22 in a procedure for authenticating a user, the signature information control unit 25 compares the newly received signature information with the signature information registered in the dictionary 2. Then, the signature information control unit 25 sends the result of the comparison to the display control unit 23. Specifically, if the degree of similarity of the two pieces of signature information is higher than a predetermined threshold value, it is judged that the user who has signed in the registration procedure and the user who has signed in the authentication procedure are the same person. On the other hand, if the degree of similarity of the two pieces of signature information is lower than the threshold value, it is judged that the user who has signed in the registration procedure and the user who has signed in the authentication procedure are different. If the authentication fails, then afterwards, for example, the user is prohibited from using a prescribed computer.

The display device 30 is a general display device, and it displays at least a hand-written pattern input via the input device 10 and contents designated by the authentication server 20. The input device 10 can be implemented as one function provided for the display device 30. That is to say, when the display area of the display device 30 is pressed by the pen 11, the coordinate data of the pressed position can be extracted and sent to the authentication server 20.

Next, the basic operation of the authentication server 20 is described. In this case, a user's signature must be registered in advance in the hand-written input authentication. Therefore, first, a procedure for registering a user's signature is described.

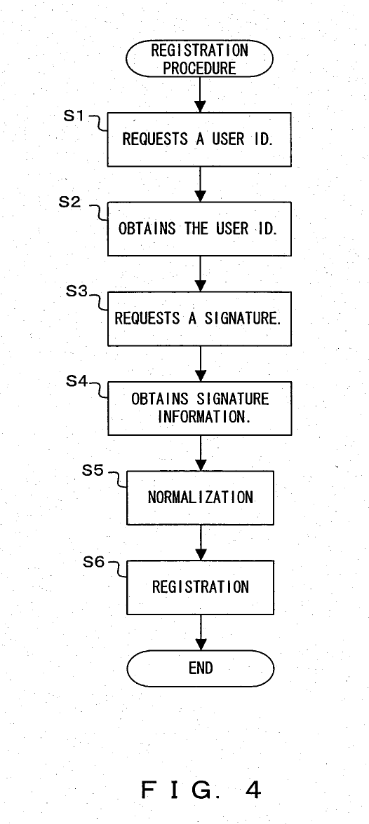

FIG. 4 is a flowchart showing the process performed by the authentication server 20 in the registration procedure. This registration procedure is executed, for example, when a user requests a user registration.

In step S1, the authentication server 20 requests the user to input his/her user ID. This request is implemented, for example, by displaying a corresponding message in the display device 30. In response to the request, the user inputs their user ID from a keyboard. Then, in step S2, the server 20 obtains the user ID.

In step S3, the server 20 requests the user to sign. This request is, for example, also implemented by displaying a corresponding message in the display device 30. In response to this request, the user signs by hand using the input device 10. Then, in step S4, the server 20 obtains signature information corresponding to the hand-written signature. As described with reference to FIG. 3, this signature information comprises a plurality of “point data” and each piece of “point data” is composed of coordinate data, pen pressure data and time data.

In step S5, a normalization process is performed. This normalization process includes, for example, a process for converting coordinate data using the start position of hand-written input as an origin. In addition, in step S5, a process for extracting a feature point of the hand-written signature pattern can be performed together with this normalization process. In this case, a feature point means, for example, the start position of a stroke, the end position of a stroke, a point at which the curvature of a signature pattern changes and the like. Furthermore, in step S5, a process for extracting a feature of the signature can also be performed together with the normalization process. In this case, the “feature of a signature” is composed of, for example, “shape”, “speed”, “acceleration” and “pen pressure”. “Shape” represents the shape of a character and the like written by a user and it can be obtained from coordinate data. “Speed” represents writing speed at which a user writes a character and the like, and it can be obtained by differentiating coordinate data by time. “Acceleration” represents a change in the speed at which a user writes a character and the like, and it can be obtained by differentiating speed data by time. “Pen pressure” represents the pen pressure with which a user writes a character and the like.

In step S6, the server 20 registers the signature information normalized in step S5, in the dictionary 27. In this case, the signature information is registered using the user ID obtained in step S2 as a retrieval key. If in step S5 a feature point is extracted, only the data of the extracted feature point can be registered in the dictionary 27. If in step S5, a feature of the signature is extracted, the feature information thereof can also be registered in the dictionary 27.

As described above, in the registration procedure, signature information corresponding to a signature hand-written by a user is registered in the dictionary 27 using a user ID identifying a user as a retrieval key.

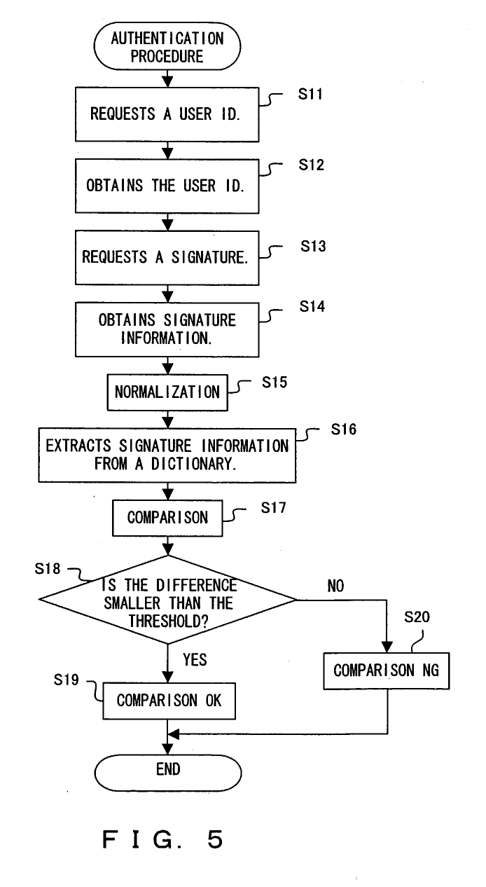

FIG. 5 is a flowchart showing processes performed by the authentication server 20 in the authentication procedure. This authentication procedure is executed, for example, when a user inputs a request to use a prescribed computer. The authentication procedure is executed assuming the completion of the registration procedure described above.

Steps S11 through S15 are the same as steps S1 through S5 executed in the registration procedure. Specifically, the authentication server 20 obtains a user ID and signature information, and normalizes the signature information.

In step S16, the server 20 extracts corresponding signature information from the dictionary 27 using the user ID obtained in step S12 as a retrieval key. Then, in steps S17 and S18, the server 20 compares the signature information obtained in step S14 with the signature information extracted from the dictionary 27. This comparison process can be executed by the prior art. For example, this comparison process can be executed by comparing the respective shapes of hand-written input patterns in which the respective coordinates of corresponding features are compared, and/or comparing respective writing speeds, writing accelerations and pen pressures.

If the difference between two pieces of signature information is smaller than a predetermined threshold value, it is judged that the user who has signed by hand in the registration process and the user signing by hand in the authentication process are the same person. In other words, it is judged that the user signing by hand in the authentication process is an authorized user. In this case, in step S19, “OK” is issued as the result of the comparison, and afterwards, the user can be permitted to use a prescribed computer. On the other hand, if the difference between two pieces of signature information is larger than the predetermined threshold value, it is judged that the user who has signed by hand in the registration process and the user signing by hand in the authentication process are different. In other words, it is judged that the user signing by hand in the authentication process is an unauthorized user. In this case, in step S20, “NG” is issued as the result of the comparison, and afterwards, the user is prohibited from using the prescribed computer.

As described above, the authentication server 20 compares signature information registered in advance with newly input signature information, and judges whether a user is an authorized user.

The hand-written input authentication system of the embodiment performs the authentication process and also has a function to improve security or a function to improve authentication accuracy.

First Embodiment

In the conventional system for authenticating a user based on hand-written input, a character string used to authenticate a user is usually the name of the user or a character string describing some attribute of the user. At least, in most cases, a character string for authenticating a user is chosen by the user. The problems that derive from this method have been described above.

However, in the authentication system of the first embodiment, the authentication server 20 determines the character string used to authenticate a user (hereinafter sometimes called a “password”). In this case, this password is composed of characters suitable for signature comparison. It is experimentally known that in a hand-written input authentication system, if a character with many strokes (in particular, Japanese Kanji character or Chinese character) is used, authentication accuracy is high, and if a character with few strokes is used, authentication accuracy is low. For this reason, in the authentication system of the first embodiment, the authentication server 20 selects a character with many strokes, for a character used to authenticate a user. In this example, for a character used to authenticate a user, for example, a character with ten or more strokes included in JIS (Japanese Industrial Standards) level-1/level-2 kanji sets, is used. The password is not necessarily composed of a plurality of characters; it can also be one character.

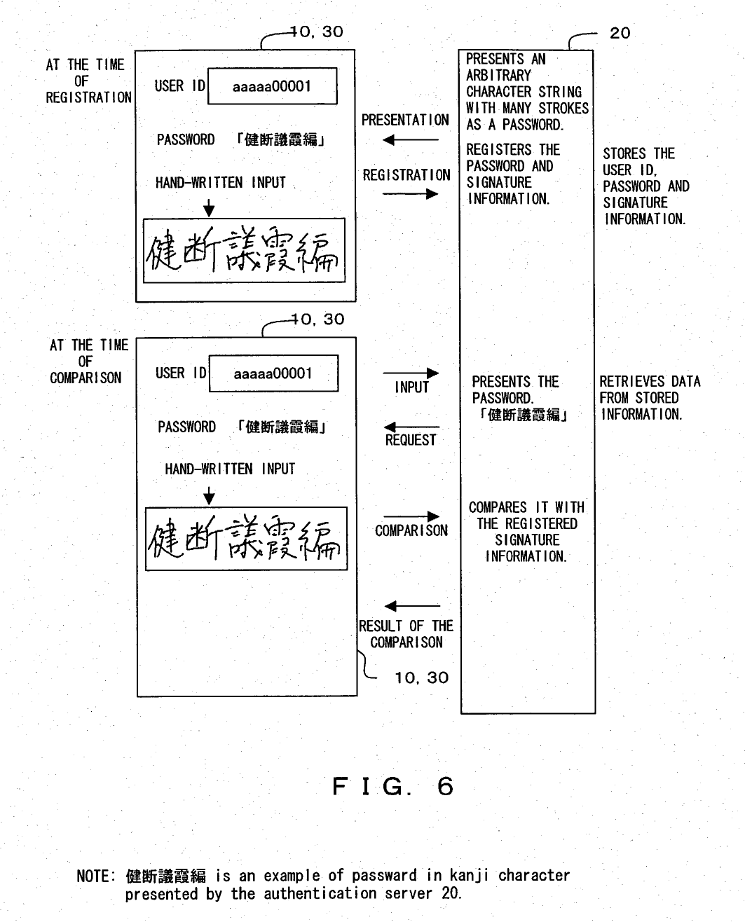

FIG. 6 shows the process flow of an authentication method of the first embodiment. The authentication server 20 used in the first embodiment makes a request for the user's user ID. Simultaneously, the server 20 creates the password including one or more characters and presents it to the user. In this example, “ [symbol] ”, “ [symbol] ”, “ [symbol] ”, “ [symbol] ” and “ [symbol] ” (each of them are Kanji character or Chinese character) are presented to the user.

The user inputs their user ID in response to the request, and also hand-writes the password presented by the authentication server 20. In this case, the user ID is, for example, input from a keyboard. The presented character string is hand-written using the pen 11 through the input device 10.

The authentication server 20 creates signature information based on the hand-written input of the user. In this case, as described above, the signature information is composed of time data, coordinate data and pen pressure data. This signature information is also normalized. Then, the authentication server 20 registers the character code of each character constituting the password presented to the user and the signature information in the dictionary 27.

When the user attempts to use a prescribed computer after completing the registration described above, the authentication procedure starts. In the authentication procedure, the authentication server 20 first makes a request for the user's user ID. Then, in response to the request, the user inputs their user ID. In this way, the authentication server 20 obtains the user ID of a user to be authenticated.

Then, the authentication server 20 accesses the dictionary 27 using the input user ID as a retrieval key and extracts corresponding characters. Here, the extracted character is the same password which has been presented to the user in the registration procedure. Furthermore, the authentication server 20 requests a user to write the password. Then, the user hand-writes the requested password.

The authentication server 20 creates signature information based on the new hand-written input and normalizes the information. Then, the server 20 extracts corresponding signature information from the dictionary 27 using the user ID input at the beginning of the authentication procedure as a retrieval key. After that, the server 20 compares the signature information extracted from the dictionary 27 with the signature information corresponding to the new hand-written input and outputs the result of the comparison.

Since in the authentication system of the first embodiment, a character string suitable for high authentication accuracy is used as the character string to authenticate a user, security is improved. In addition, since a character string unrelated to any attributes of the user is used to authenticate a user, there is little possibility that a signature hand-written during user authentication procedure may be successfully forged. This point also contributes to improving security.

In this embodiment, a password used in the registration procedure (five kanji characters) is used in the authentication procedure too without any modifications. However, the present invention is not limited to this method. Specifically, for example, in the registration procedure, N characters are presented and N pieces of corresponding signature information are registered in advance. Then, in the authentication procedure, the authentication server 20 can make a user write K characters randomly selected from the N characters. By introducing this method, a different character string is used for each authentication operation. Therefore, forging the signature is made more difficult and authentication accuracy can be further improved accordingly.

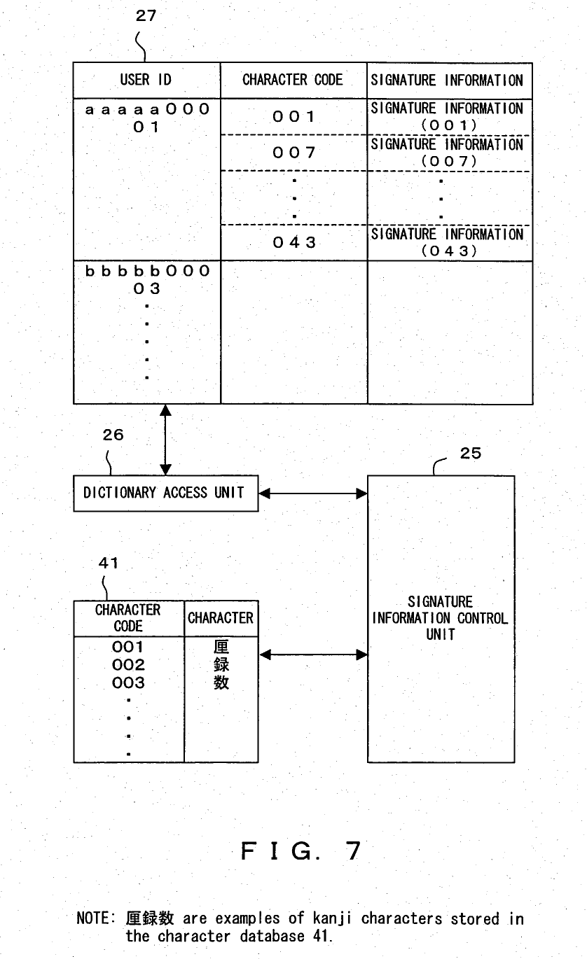

FIG. 7 shows information registered in the dictionary 27 in the first embodiment. In the first embodiment, the authentication server 20 comprises a character database 41. In the character database 41, characters suitable for signature comparison are registered in advance. It is assumed that characters suitable for signature comparison are selected in advance, for example, based on experiments, simulations, or experience. A character code identifying each character is attached to each character registered in the character database 41. In the registration procedure to register user's signature, N characters are randomly selected from this character database 41 and are presented to the user as a password. In this case, the character codes corresponding to the characters presented to the user are registered in the dictionary 27 using their user ID as a retrieval key. Furthermore, when a user hand-writes the characters presented, corresponding signature information is registered in the dictionary 27 in relation to each character code.

Next, the registration and authentication procedures of the first embodiment are described with reference to the flowcharts.

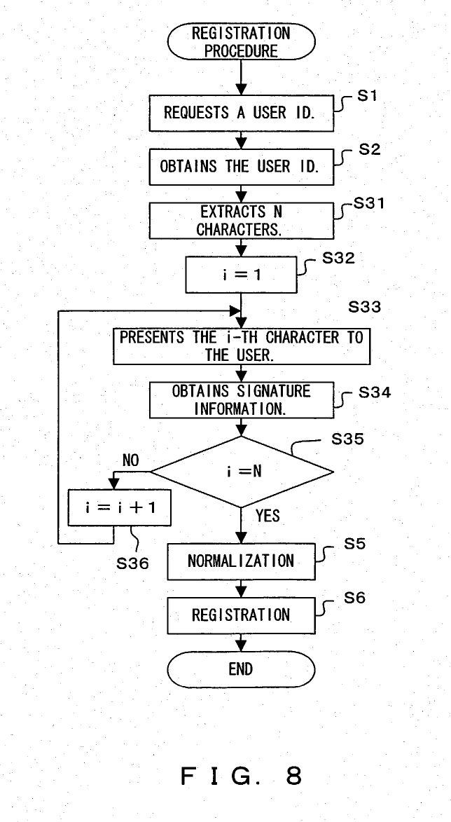

FIG. 8 is a flowchart showing the process of the authentication server in the registration procedure of the first embodiment. In the registration procedure of the first embodiment, the operation of the authentication server 20 is basically the same as the basic operation shown in FIG. 4. However, in the first embodiment, steps S31 through S36 shown in FIG. 8 are executed instead of steps S3 and S4 shown in FIG. 4.

In step S31, N characters are randomly extracted from the character database 41. In step S32, variable i is initialized. “Variable i” is used to call N characters from the character database 41 in order one by one. In step S33, the i-th character of the N characters extracted from the character database 41 is presented to the user. In response to this presentation, the user hand-writes the characters.

In step S34, signature information corresponding to the user's hand-written input is obtained. In step S35, it is checked whether all the N characters extracted in step S31 have been presented to the user. If there is still a character that has not been presented to the user, variable i is incremented in step S36, then the flow returns to step S33 to present the next character to the user. If all the extracted characters have already been presented to the user, the normalization process in step S5 is executed.

Then, in step S6, the character code of each character presented to the user and corresponding signature information are registered in the dictionary 27. Here, as shown in FIG. 7, the character code and signature information are registered using the user ID obtained in step S2 as a retrieval key.

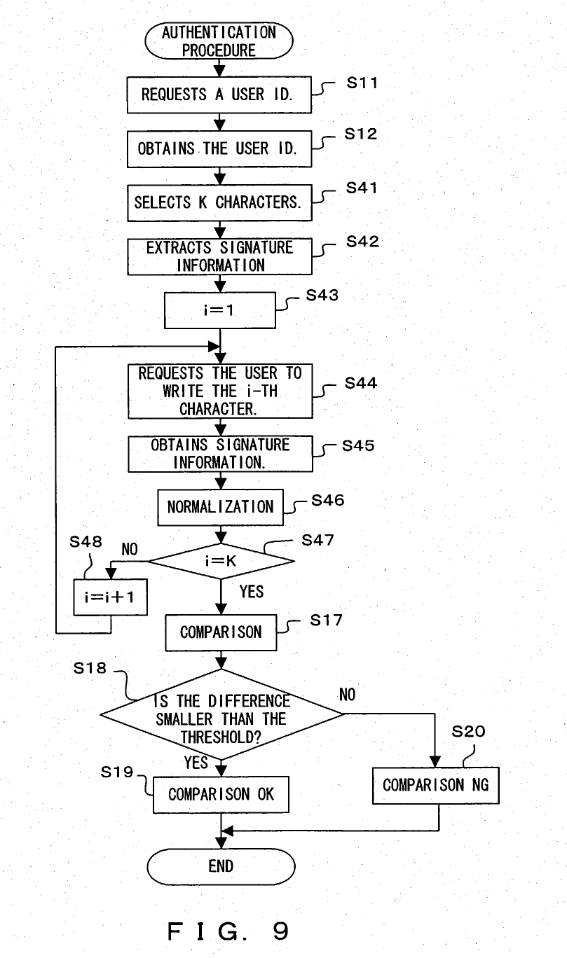

FIG. 9 is a flowchart showing the process of the authentication server in the authentication procedure of the first embodiment. In the authentication procedure of the first embodiment, the operation of the authentication server 20 is basically the same as the operation shown in FIG. 5. However, in the first embodiment, steps S41 through S48 shown in FIG. 9 are executed instead of steps S13 through S16 shown in FIG. 5.

In step S41, K characters are randomly extracted from the N characters registered in the dictionary 27. In step S42, K pieces of signature information corresponding to the K characters are extracted from the dictionary 27.

In step S43, variable i is initialized. In this case, the variable i is used to call the K characters extracted from the dictionary 27 in order one by one. In step S43, the user is requested to write the i-th character of the K characters extracted from the dictionary 27. In this case, the user hand-writes the character requested by the authentication server 20.

In step S45, signature information corresponding to the user's hand-written input is obtained. In step S46, the signature information obtained in step S45 is normalized. In step S47, it is checked whether all the K characters extracted in step S41 have been presented to the user. If there is still a character that has not been presented to the user, variable i is incremented in step S48, and then the flow returns to step S44 to present the next character to the user. If all the extracted characters have already been presented to the user, the flow proceeds to step S17.

Then, in steps S17 through S20, the newly obtained signature information and the signature information registered in the dictionary 27 are compared and the result is output.

In the examples shown in FIGS. 8 and 9, when a user is requested to write a plurality of characters, the authentication server 20 makes the user to write the plurality of characters in order one by one. However, the authentication sever 20 may make the user to write the plurality of characters at one time.

The number N of characters registered in the registration procedure and the number K of characters used in the authentication procedure can also be the same.

Furthermore, although in this embodiment described above, the authentication server 20 presents a prescribed character to a user, a figure or a symbol can also be presented instead of a character.

Second Embodiment

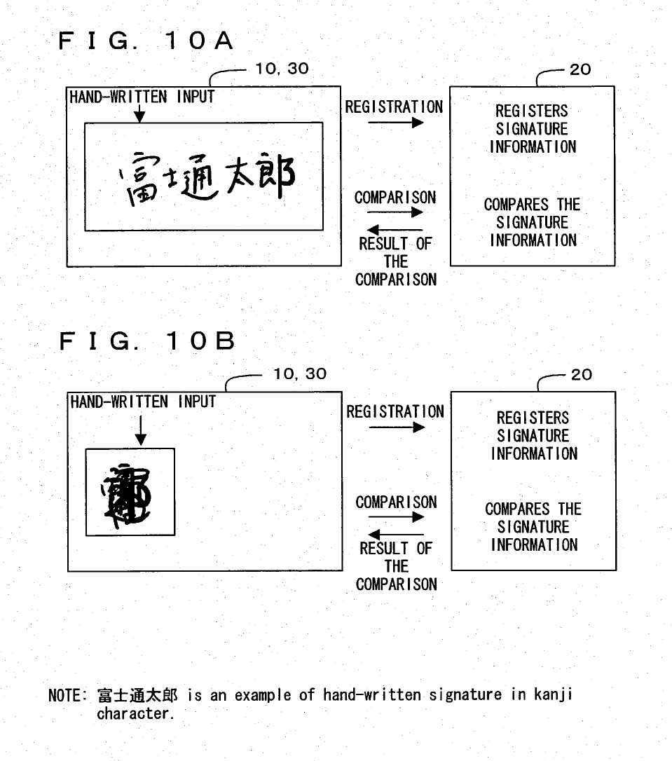

In the second embodiment, a character string used to authenticate a user is composed of a plurality of characters, and the plurality of characters can be written overlapped. Specifically, in a general hand-written signature authentication system, as shown in FIG. 10A, a user hand-writes their name in the input area of the input device 10. In this example, a user writes five kanji characters. In this case, the characters are written so as not to overlap. However, in the second embodiment, as shown in FIG. 10B, when a user hand-writes their name, the characters overlap.

In a general hand-written signature authentication system, a signature pattern drawn by a user using the input device 10 is displayed in the display device 30 without being modified. Therefore, as shown in FIG. 10A, when a user writes their name, the signature is displayed in the display device 30 without being modified and the signature is visible for anybody. In other words, there is a possibility that the signature as authentication information may leak. In addition, for the plurality of characters not to overlap, the input device 10 must have a fairly large input area.

On the other hand, if a user's name is written as shown in FIG. 10B, the signature pattern is displayed in such a way that the plurality of characters overlap. Therefore, even if another person sees the written content, it is very difficult for each character to be recognized. As a result, there is little possibility that the signature as authentication information may leak, and security can be improved accordingly. In addition, since the plurality of characters are allowed to overlap, there is no need for the input device 10 to have a large input area.

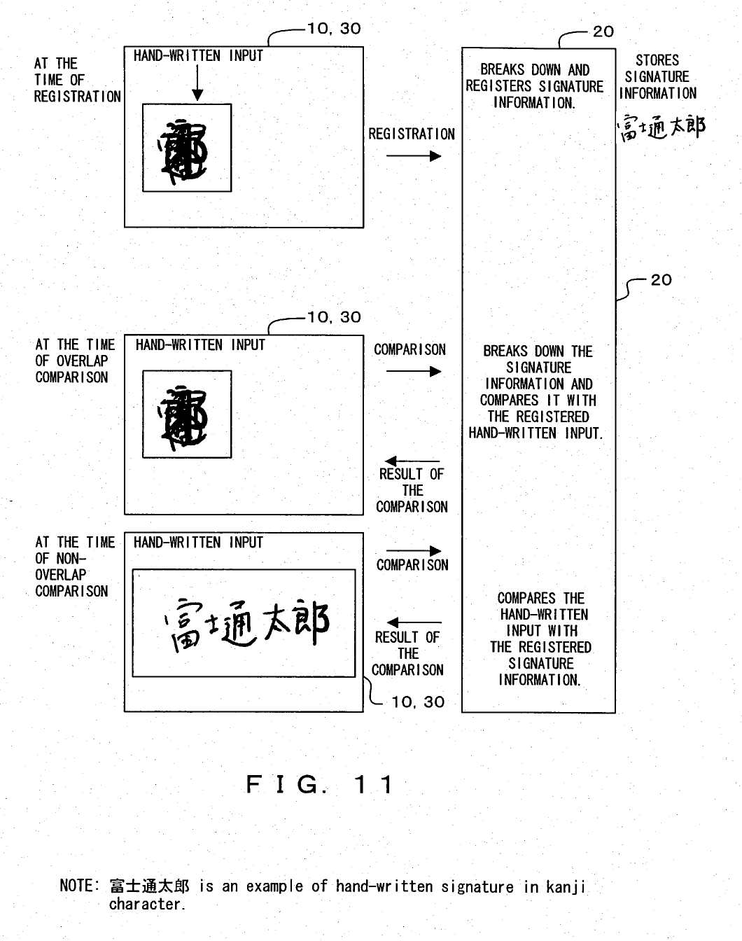

FIG. 11 shows the process flow of the authentication method of the second embodiment. In the second embodiment, when signing their name in the registration procedure, a user overlaps the characters. Then, the authentication server 20 breaks down signature information created based on the user's hand-written input into written strokes and registers the information in the dictionary 27. In this case, a “stroke” means a time period during which the pen 11 continuously touches the input area of the input device 10, or a writing operation during this time period. Therefore, the start of a stroke can be detected when “pen pressure data” changes from zero to non-zero. Similarly, the end of a stroke can be detected when “pen pressure data” changes from non-zero to zero.

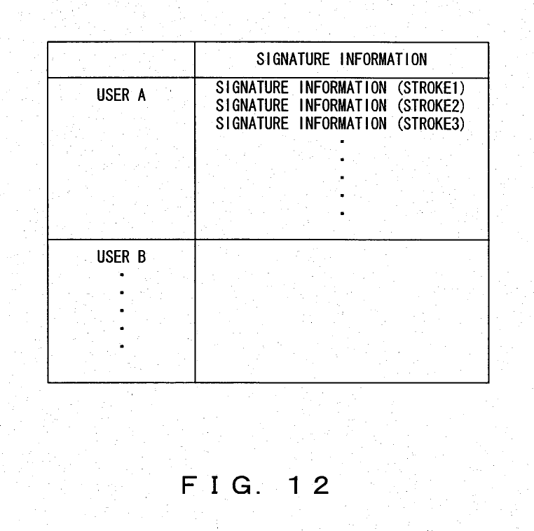

FIG. 12 shows the structure of the dictionary 27 used in the system of the second embodiment. In the second embodiment, as described above, signature information is broken down into written strokes and registered.

When a user attempts to use a prescribed computer after completing registration, an authentication procedure starts. In the authentication procedure, the user signs their name again. On receipt of the signature, the authentication server 20 breaks down signature information created based on the signature, into written strokes as in the process of registration procedure. Then, the newly created signature information and the signature information registered in the dictionary 27 are compared stroke by stroke and the result is output.

As described above, in the authentication system of the second embodiment, since overlapping characters are allowed, it is very difficult to recognize each character even if a signature hand-written by a user is displayed in the display device 30. Therefore, the security of the authentication system can be improved.

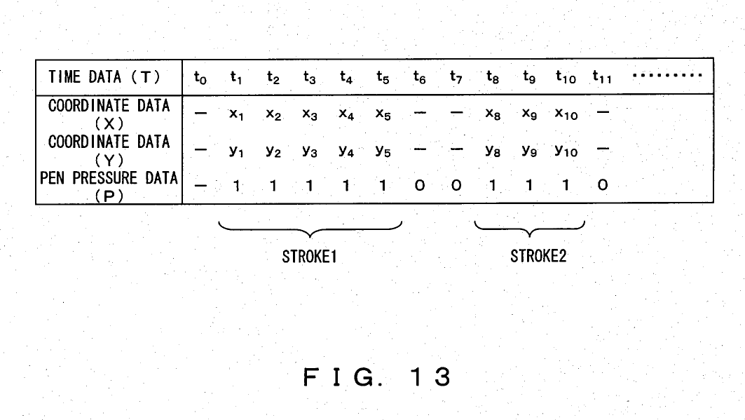

Next, a method for breaking down signature information into written strokes is described. In this description, it is assumed that the signature information shown in FIG. 13 has been obtained. As described above, the signature information is composed of time data (t), coordinate data (x,y) and pen pressure data (p). In this example, it is assumed that “pen pressure data” is binary and that it indicates “1” when the pen 11 touches the input area of the input device 10 and “0” when it doesn't.

Each stroke starts when pen pressure data changes from zero to non-zero, and ends when pen pressure data changes from non-zero to zero. For example, in FIG. 13, “stroke 1” starts at time t1 and ends at time t5. Therefore, in this case, a plurality of pieces of time data, coordinate data and pen pressure data at each of t1 through t5 are grouped together as signature information corresponding to stroke 1. Similarly, a plurality of pieces of time data, coordinate data and pen pressure data at each of t8 through t10 are grouped together as signature information corresponding to “stroke 2”.

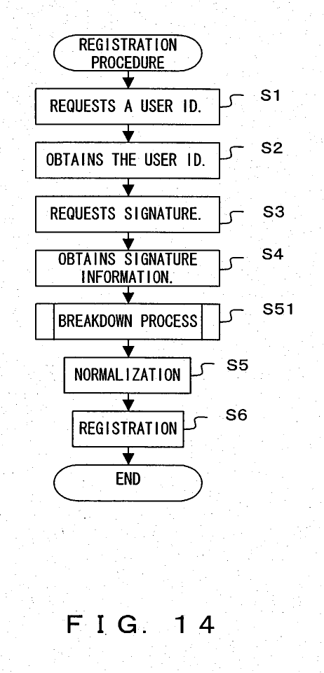

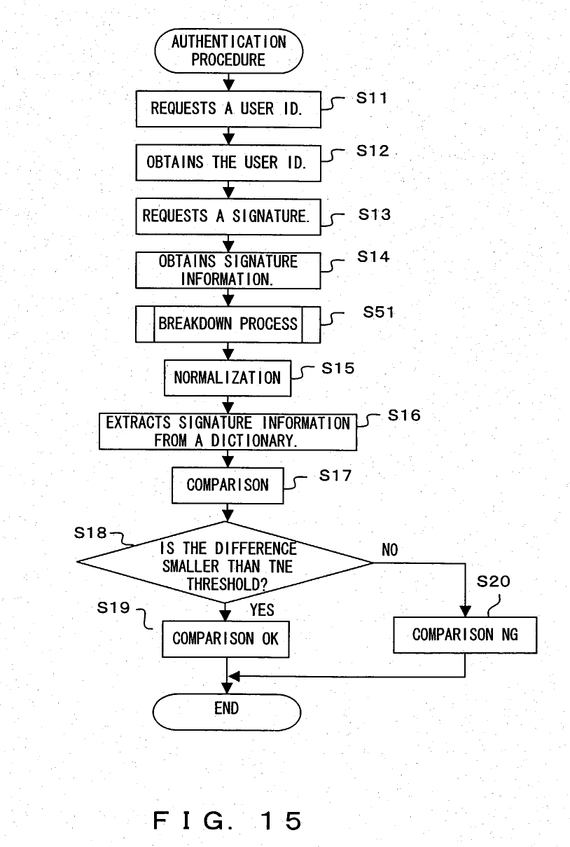

The registration and authentication procedures of the second embodiment are basically the same as those shown in FIGS. 4 and 5, respectively. However, in the registration procedure of the second embodiment, as shown in FIG. 14, step S51 is executed between steps S4 and S5. Similarly, in the authentication procedure, as shown in FIG. 15, step S51 is executed between steps S14 and S15. Step S51 shown in FIGS. 14 and 15 is a process for breaking down signature information into written strokes.

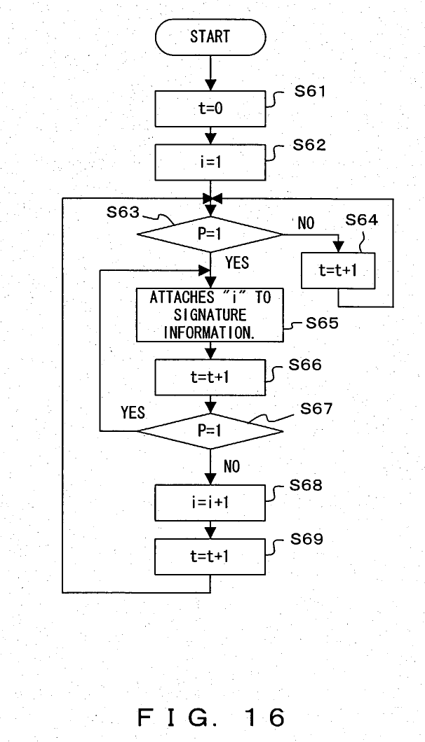

FIG. 16 is a flowchart showing the process of breaking down signature information into written strokes. This process is executed when signature information is obtained in step S4 shown in FIG. 14 or in step S14 shown in FIG. 15.

In steps S61 and S62, variables t and i, respectively, are initialized. In this flowchart, “variable t” is an identification number for identifying each timing when coordinate and pen pressure data were detected in the input device 10. In this flowchart, “variable i” is a stroke number identifying each stroke.

In step S63, it is checked whether the pen 11 touches the input area of the input device 10, by referring to pen pressure data p detected at the timing designated by variable t. If pen pressure data p=0, it is judged that the pen 11 is not touching the input area of the input device 10 and variable t is incremented in step S64. That is to say, the processes in steps S63 and S64 are repeated until pen pressure data p=1 is obtained.

If in step S63 pen pressure data p=1 is obtained, it is judged that the pen 11 is touching the input area of the input device 10 and the flow proceeds to step S65. In step S65, a stroke number designated by variable i is attached to each of the respective pieces of coordinate data and pen pressure data that are detected at the timing designated by variable t. In step S66, variable t is incremented.

In step S67, it is checked whether the pen 11 is touching the input area of the input device 10 at the timing designated by variable t. If the pen 11 is touching the input area of the input device 10, it is judged that the stroke continues, and the flow returns to step S65. Then, a stroke number “i” is attached to each of the respective pieces of coordinate and pen pressure data that correspond to variable t. However, if the pen 11 is not touching the input area of the input device 10, it is judged that the stroke has ended and the flow proceeds to step S68.

In steps S68 and S69, variables t and i, respectively, are incremented. Then, the flow returns to step S63, and the processes in steps S63 through S69 are repeated until there is no un-processed signature information left.

After steps S61 through S69 are executed, a normalization process (step S5 shown in FIG. 14 or step S15 shown in FIG. 15) is executed. In this case, each piece of signature information broken down into written strokes is normalized using the start point of each stroke as a reference point.

Next, the process of this flowchart is described in detail using the example shown in FIG. 13. First, since at time t0, pen pressure data p=0 is obtained, the judgment in step S63 is “No”. Then, at time t1, pen pressure data p=1 is obtained, the judgment in step S63 is “Yes”. Therefore, the process in step S65 is executed, and a stroke number “i=1” is attached to each of the respective pieces of coordinate data and pen pressure data that are detected at time t1.

Then, since at each of time t2 through t5, pen pressure data p=1 is obtained, the processes in steps S65 through S67 are repeated and a stroke number “1” is attached to each of the respective pieces of coordinate data and pen pressure data that are detected at each of time t2 through t5. As a result, a plurality of pieces of the coordinate data and pen pressure data that are detected at each of time t1 through t5 are grouped together as data belonging to “stroke 1”.

Then, since at time t6, pen pressure data P=0 is obtained, the judgment in step S67 is “No”, and variable i is incremented from “1” to “2”. Then, at the timing t8 through t10, pen pressure data p=1 is obtained, a stroke number “2” is attached to each of the respective pieces of coordinate data and pen pressure data that are detected during the period. As a result, a plurality of pieces of coordinate data and pen pressure data that are detected during the timing t8 through t10 are grouped as data belonging to “stroke 2”.

Then, in the registration procedure, the signature information broken down into written strokes is registered in the dictionary 27 using each user ID as a retrieval key, as shown in FIG. 12. On the other hand, in the authentication procedure, the signature information broken down into written strokes is compared with the signal information that has been broken down into written strokes and is stored in the dictionary 27.

As described above, in the authentication system of the second embodiment, since a user's signature is compared per written stroke, the user can be authenticated even if characters overlap. As a matter of course, even if characters are written so as not to overlap, similarly the user can be authenticated.

In the system where characters and the like written using the input device 10 are displayed in the display device 30, it is likely that the user usually will write them while looking at their written traces displayed in the display device 30 in real time. However, in the system of the second embodiment, since characters overlap, sometimes a user cannot confirm whether the shape of characters and the like he or she is writing is proper when looking at it displayed on the display device 30. That is to say, in the second embodiment, although it is intended that the user's signature cannot be seen by another person, there is a possibility that even the signer cannot confirm their signature.

In order to solve this problem, the system of the second embodiment can be designed so that when characters and the like written by a user are displayed on the display device 30, a newly drawn pattern is distinguished from other patterns and is displayed. In this case, for example, previously drawn patterns are displayed black, while a newly drawn pattern is displayed in red. Then, when a prescribed time has elapsed, the pattern color displayed is also changed from red to black. Specifically, for example, only patterns drawn within the past ten seconds are displayed in red. Alternatively, only the current stroke is displayed in red. Alternatively, the drawn pattern can be hidden a prescribed time after characters and the like are written in the input device 10.

As described above, the system of the second embodiment is designed so that a hand-written signature cannot be seen by another person, but is also provided with a function to allow only the signer to see the signature.

Third Embodiment

Generally, a signature written by a user in a system for receiving hand-written input is traced and written by a cursor on the display screen. In this case, a user can usually select the shape of the cursor. In the system of the third embodiment, the shape of the cursor selected by a user is used as information for authenticating the user.

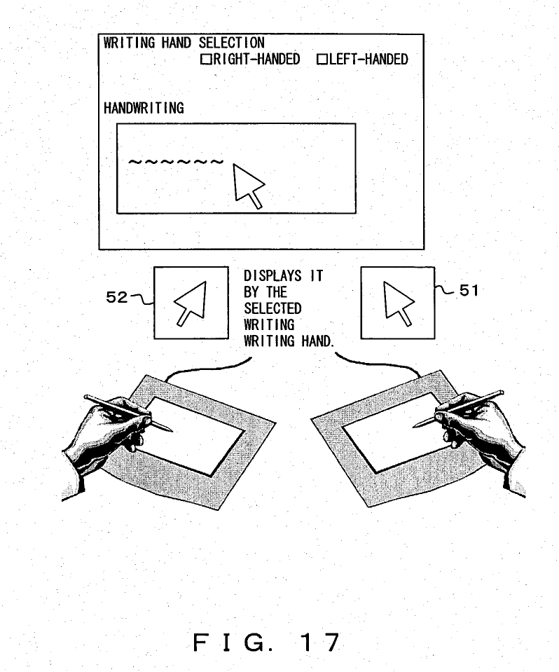

As shown in FIG. 17, the authentication server 20 of the third embodiment asks the user which hand (right-handed/left-handed) is his/her writing hand. When the user selects his/her writing hand, a cursor with a shape corresponding to the selected writing hand is displayed in the display device 30. In this case, generally a right-handed user prefers a cursor with a shape pointing to the upper left corner. Therefore, if “right-handed” is selected, cursor 51 is displayed. On the other hand, a left-handed user generally prefers a cursor pointing to the upper right corner. Therefore, if “left-handed” is selected, the cursor 52 is displayed. Then, the user signs their name.

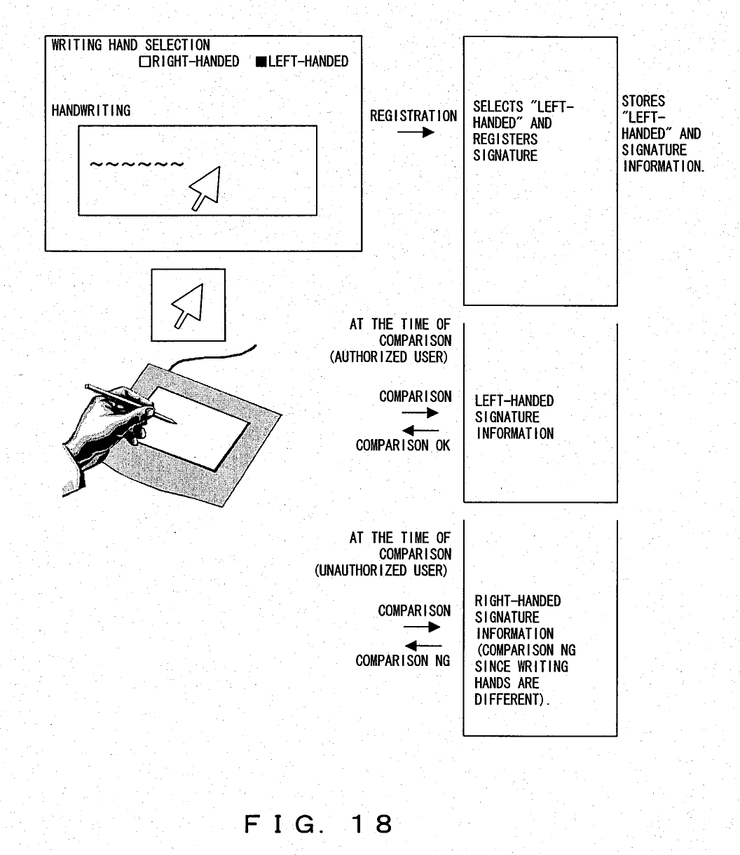

The authentication server 20 receives the writing hand information selected by the user and creates signature information corresponding to the signature. Then, as shown in FIG. 18, the authentication server 20 registers the writing hand information and signature information in the dictionary 27. In this case, these pieces of information are registered using the user's user ID as a retrieval key.

When signing their name in the authentication procedure, the user selects their writing hand again. Then, the authentication server 20 compares the respective signatures as well as respective writing hands selected by the user. Only when not only the signatures but also writing hands are the same, the server 20 authenticates the user. If the signatures are the same but the writing hands are different, the user is judged to be an unauthorized user.

Since as described above, in the third embodiment, not only user's respective signatures but also the respective writing hands are compared, the security of the authentication system can be improved. In this case, the fact that writing hand information is used for user authentication is not disclosed to the user. In other words, authentication accuracy can be improved without a user being aware of it.

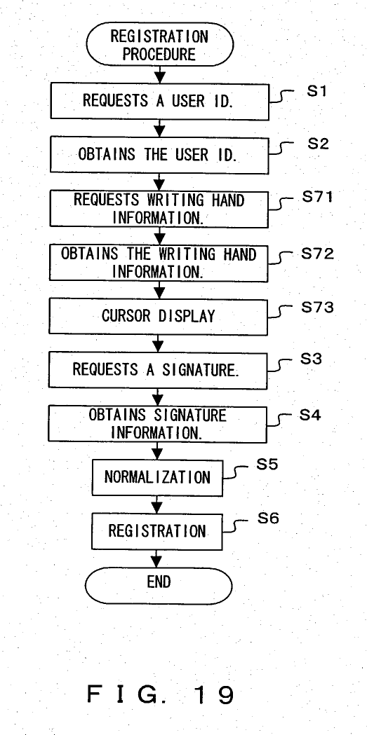

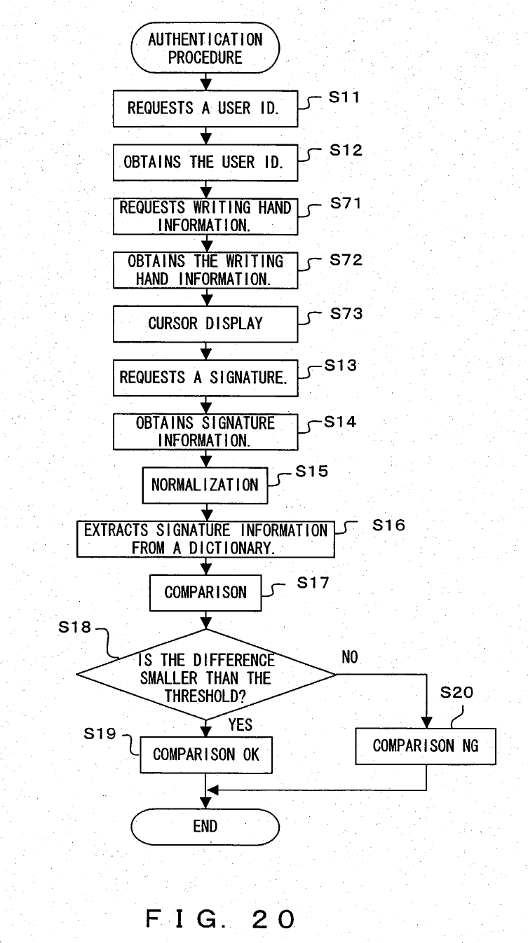

The registration procedure and authentication procedure of the third embodiment are basically the same as those shown in FIGS. 4 and 5, respectively. However, in the registration procedure of the third embodiment, as shown in FIG. 19, steps S71 through S73 are executed between steps S2 and S3. Similarly, in the authentication procedure, as shown in FIG. 20, steps S71 through S73 are executed between steps S12 and S13.

In step S71, as shown in FIG. 17, the authentication server 20 asks the user which hand is his/her writing hand. In this case, a question message is displayed on the display device 30. In step S72, writing hand information is obtained. In this case, the writing hand information is input by the user. Then, in step S73, a cursor corresponding to the writing hand information is displayed on the display device 30.

Then, in the registration procedure, in step S6 shown in FIG. 19, writing hand information and signature information are registered using the user's user ID as a retrieval key. In the authentication procedure, in step S17 shown in FIG. 20, not only the signature information but also writing hand information is compared and the results are output.

Although in the example described above, the authentication server 20 make a user select a writing hand, the server 20 may make a user select a desired cursor shape instead. Alternatively, authentication can be performed by comparing a cursor shape selected at the time of authentication with a cursor shape registered in advance.

Although in the examples described above, the first through third embodiments are separately described, the configurations or functions disclosed in these embodiments may be combined.

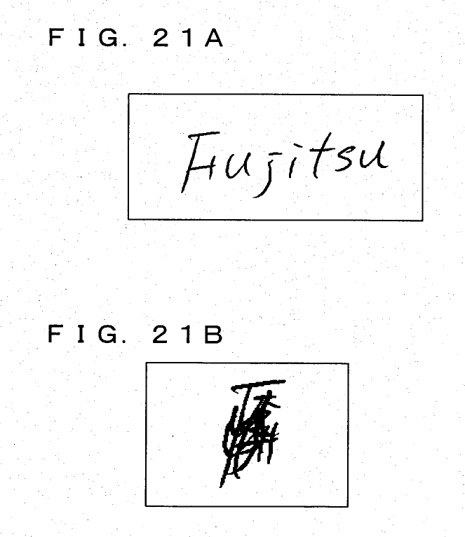

Although in the examples described above, an example of a signature in kanji (Chinese character) is shown, the present invention is not limited to this. Specifically, the present invention can also be applied to a signature in hiragana or katakana, or an alphabetical signature. For examples, alphabetical examples are shown in FIGS. 21A and 21B. Specifically, FIG. 21A shows an example where characters are written so as not to overlap. FIG. 21B shows an example where characters overlap (corresponds to the second embodiment).

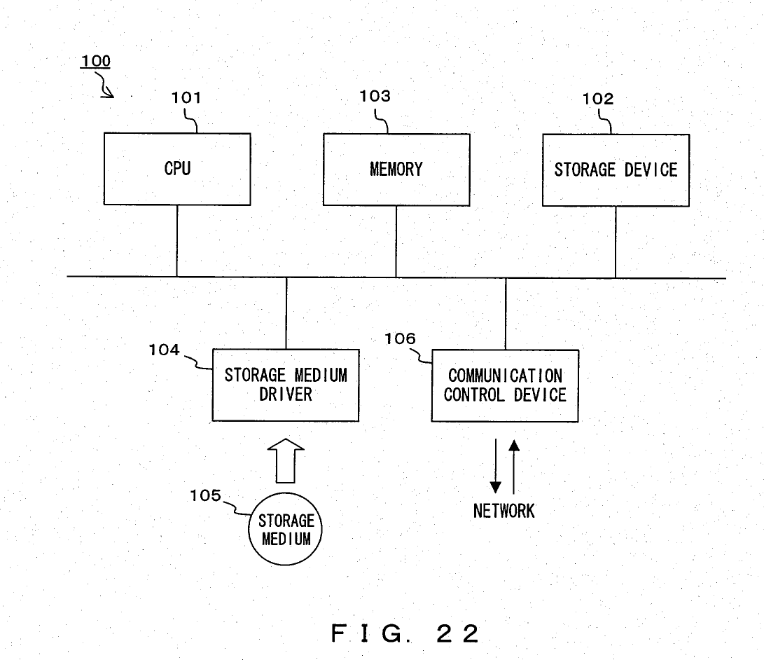

The authentication function described above can be realized by executing software programs enabling a computer (in the embodiments, authentication server 20) to perform the process shown in the flowcharts described above. FIG. 22 shows the configuration of a computer 100 executing such a programs.

In FIG. 22, a CPU 101 loads a program describing the process shown in the flowcharts into a memory 103 from a storage device 102 and executes it. The storage device 102 stores the program and also stores the dictionary 27. For the storage device, a hard disk or the like is used. The storage device 102 can also be an external storage device connected to the computer 100. The memory 103 is used as the work area of the CPU 101. For the memory 103, a semiconductor memory or the like are used.

A storage medium driver 104 accesses a portable storage medium 105 according to the instructions of the CPU 101. For the portable storage medium 105, a semiconductor device (PC card, etc.), a medium to/from which information is magnetically input/output (flexible disk, magnetic tape, etc.), a medium to/from which information is optically input/output (optical disk, etc.) and the like can be used. A communication control device 106 transmits/receives data to/from a network according to the instructions of the CPU 101.

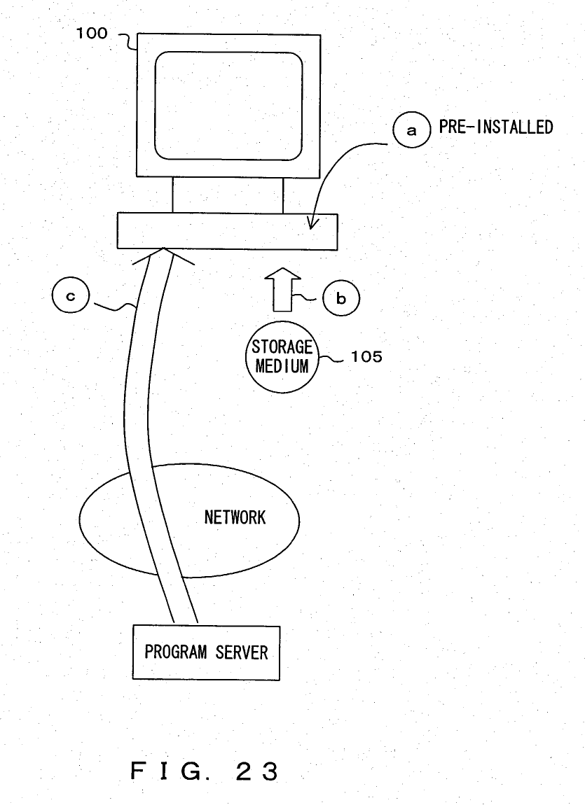

FIG. 23 shows the provision methods of the software program of the present invention. The program of the present invention is, for example, provided by any of the following three methods.

(1) The program is installed in the computer 100 and is provided. In this case, the program is, for example, installed in advance prior to the shipment of the computer 100.

(2) The program is stored and provided in the portable storage medium 105. In this case, the program stored in the portable storage medium 105 is, for example, installed on the storage device 102 through the storage medium driver 104.

(3) The program is provided by a program server in a network. In this case, the computer 100 obtains the program by downloading the program stored in the program server.

According to the present invention, since the authentication accuracy of a hand-written signature can be improved, the security of a computer and the like can be improved. Even if an input area for handwriting is small, sufficient authentication accuracy can be obtained.

What is claimed is:

1. A computer program enabling a computer to perform method steps for a user authentication, said method steps comprising:
presenting a password to a user in a registration procedure;
registering signature information hand-written by the user in response to the presentation;
requesting the user to hand-write the password in an authentication procedure; and
authenticating the user based on the result of comparing signature information that is hand-written by the user in response to the request and the registered signature information.

2. The computer program according to claim 1, wherein the password includes a character and the character is selected from characters each with over a prescribed number of strokes.

3. A computer program enabling a computer to perform method steps for a user authentication, said method steps comprising:
presenting a password composed of a plurality of characters to a user in a registration procedure;
registering signature information hand-written by the user in response to the presentation;
requesting the user to hand-write a part of the plurality of characters constituting the password in an authentication procedure; and
authenticating the user based on the result of comparing signature information hand-written by the user in response to the request and the registered signature information.

4. The computer program according to claim 3, wherein one or more characters is selected randomly from the plurality of characters in each authentication procedure.

5. A computer program enabling a computer to perform method steps for a user authentication, said method steps comprising:
presenting a character, figure or symbol to a user in a registration procedure;
registering signature information hand-written by the user in response to the presentation;
requesting the user to hand-write the character, figure or symbol presented to the user in the registration procedure; and
authenticating the user based on the result of comparing the signature information hand-written by the user in response to the request with the registered signature information.

6. An authentication method for authenticating a user based on hand-written input, comprising:
presenting a password to a user in a registration procedure;
registering signature information hand-written by a user in response to the presentation;
requesting a user to hand-write the password in an authentication procedure; and
authenticating the user based on the result of comparing signature information hand-written by the user in response to the request and the registered signature information.

7. The method according to claim 6, wherein the password includes a character and the character is selected from characters each with over a prescribed number of strokes

8. An authentication method for authenticating a user based on hand-written input, comprising:
presenting a password composed of a plurality of characters to a user in a registration procedure;
registering signature information hand-written by the user in response to the presentation;
requesting the user to hand-write a part of the plurality of characters constituting the password in an authentication procedure; and
authenticating the user based on the result of comparing signature information hand-written by the user in response to the request with the registered signature information.

9. The method according to claim 8, wherein the character to be hand-written by the user in the authentication procedure is randomly selected from the plurality of characters in each authentication procedure.

10. An authentication method for authenticating a user based on hand-written input, comprising:
presenting a character, figure or symbol to a user in a registration procedure;
registering signature information hand-written by the user in response to the presentation;
requesting the user to hand-write the character, figure or symbol presented to the user in the registration procedure; and
authenticating the user based on the result of comparing the signature information hand-written by the user in response to the request with the registered signature information.

11. A hand-written input authentication apparatus authenticating a user based on hand-written input, comprising:
a presenting unit presenting a password to a user in a registration procedure;
a registering unit registering signature information hand-written by the user in response to the presentation;
a requesting unit requesting the user to hand-write the password in an authentication procedure; and
a authenticating unit authenticating the user based on the result of comparing signature information hand-written by a user in response to the request and the registered signature information.

12. A computer program enabling a computer to perform method steps for a user authentication, said method steps comprising:
breaking down signature information hand-written by a user in a registration procedure into written strokes and registering the signature information;
breaking down signature information hand-written by the user in an authentication procedure into written strokes; and
authenticating the user based on the result of comparing the signature information obtained in the authentication procedure with the signature information stored in the registration procedure stroke by stroke.

13. The computer program according to claim 12, further comprising displaying newly hand-written trace such that the newly hand-written trace can be distinguishable from other hand-written trace.

14. A hand-written input authentication method for authenticating a user based on hand-written input, comprising:
presenting a password to a user in a registration procedure;
registering signature information hand-written by a user in response to the presentation;
requesting a user to hand-write the password in an authentication procedure; and
authenticating the user based on the result of comparing signature information hand-written by the user in response to the request and the registered signature information.

15. The method according to claim 14, wherein newly hand-written trace is displayed such that the newly hand-written trace can be distinguishable from other hand-written trace.

16. A hand-written input authentication apparatus for authenticating a user based on hand-written input, comprising:
a first breaking unit breaking down signature information hand-written by a user in a registration procedure into written strokes and registering the signature information;
a second breaking unit breaking down signature information hand-written by a user in an authentication procedure into written strokes; and
a authenticating unit authenticating the user based on the result of comparing the signature information obtained in the authentication procedure and the registered signature information stroke by stroke.

17. An authentication method for authenticating a user based on hand-written input, comprising:
registering writing hand information input by a user and signature information hand-written by a user in a registration procedure;
making a request for writing hand information and a hand-written signature to the user in an authentication procedure; and
authenticating the user based on the result of comparing the writing hand information input in response to the request with the registered writing hand information and the result of comparing the signature information hand-written in response to the request with the signature information registered in the registration procedure.

18. A hand-written input authentication method for authenticating a user based on hand-written input, comprising:
registering a type of cursor designated by a user and signature information hand-written by the user in a registration procedure;
making a request for the type of cursor and a hand-written signature to the user in an authentication procedure; and
authenticating the user based on the result of comparing the type of cursor selected in response to the request with the registered type of cursor and the result of comparing the signature information hand-written in response to the request with the signature information registered in the registration procedure.

19. A storage medium storing a computer program enabling a computer to perform method steps for a user authentication, said method steps comprising:
presenting a password to a user in a registration procedure;
registering signature information hand-written by the user in response to the presentation;
requesting the user to hand-write the password in an authentication procedure; and
authenticating the user based on the result of comparing signature information that is hand-written by the user in response to the request and the registered signature information.
